(19) United States
(12) Patent Application Publication
(10) Pub. No.: US 2017/0324180 A1
(43) Pub. Date: Nov. 9, 2017

(54) Connector Terminal

(71) Applicants: AutoNetworks Technologies, Ltd., Yokkaichi, Mie (JP); Sumitomo Wiring Systems, Ltd., Yokkaichi, Mie (KR); SUMITOMO ELECTRIC INDUSTRIES, LTD., Osaka-shi, Osaka (JP)

(72) Inventors: Takashi NATSUME, Yokkaichi (JP); Kingo FURUKAWA, Yokkaichi (JP); Mikio SATOU, Yokkaichi (JP)

(21) Appl. No.: 15/527,762

(22) PCT Filed: Nov. 6, 2015
(86) PCT No.: PCT/JP2015/081374

§ 371 Date: May 18, 2017

(30) Foreign Application Priority Data
Nov. 19, 2014 (JP) 2014-234519

(51) Int. Cl. H01R 13/03

(52) U.S. Cl. CPC H01R 13/03

(57) ABSTRACT

A connector terminal capable of improving corrosion resistance even if a metal base material is made of Fe or Fe-based alloy. The connector terminal is made of a terminal material including a plating film on a surface of the metal base material. The metal base material is made of Fe or Fe-based alloy. The connector terminal includes a base material exposed part formed by exposing the metal base material and a coating film made of anti-rust oil and covering a surface of the base material exposed part. The base material exposed part can be present at a punched fracture surface formed by punching the terminal material and/or at a bent portion formed by bending the terminal material.

### CROSS REFERENCE TO RELATED APPLICATIONS

This application claims the priority of Japanese patent application JP2014-234519 filed on Nov. 19, 2014, the entire contents of which are incorporated herein.

### TECHNICAL FIELD

The present invention relates to a connector terminal.

### BACKGROUND ART

Conventionally, connector terminals having various shapes are used in connectors used in vehicles such as automotive vehicles. A connector terminal is generally made of a terminal material including a Sn plating film on a surface of copper alloy such as brass in many cases (see patent literature 1 JP2012-185984).

### SUMMARY

In recent years, a connector terminal has been desired which has a higher rigidity and can reduce material cost for miniaturization and cost reduction. Accordingly, it is considered to use Fe or Fe-based alloy having a high material strength and a low material cost as a metal base material for the connector terminal. In this case, it is effective to form a plating film such as a Sn plating film on a surface of Fe or Fe-based alloy as before in order to improve connection reliability.

By the presence of the above plating film, corrosion resistance can be maintained in most parts of the connector terminal. However, Fe or Fe-based alloy has an extremely low corrosion resistance as compared to brass and the like. Thus, the connector terminal of this type has a problem that corrosion easily progresses even by slight exposure of the metal base material.

The present design was developed in view of the above background and aims to provide a connector terminal capable of improving corrosion resistance even if a metal base material is made of Fe-based alloy.

One aspect of the present design is directed to a connector terminal made of a terminal material including a plating film on a surface of a metal base material, wherein the metal base material is made of Fe-based alloy containing 90 mass % or more of Fe and the connector terminal includes a base material exposed part formed by exposing the metal base material and a coating film made of anti-rust oil and covering a surface of the base material exposed part with the plating film exposed on a terminal outer surface.

In the above connector terminal, even if the metal base material is made of the above Fe-based alloy, the surface of the base material exposed part formed by exposing the metal base material is covered by the coating film made of the anti-rust oil. Thus, in the above connector terminal, direct contact of the base material exposed part having a low corrosion resistance and moisture is made difficult by the coating film and corrosion resistance can be improved.

### BRIEF DESCRIPTION OF THE DRAWINGS

FIG. 1 is a schematic external view of a connector terminal of a first embodiment,

FIG. 2 is a diagram schematically showing a part of a cross-section along II-II in the connector terminal of the first embodiment,

FIG. 3 is a schematic external view of a connector terminal of a second embodiment,

FIG. 4 is a diagram schematically showing a part of a cross-section of the connector terminal of the second embodiment,

FIG. 5 are photographs showing a result of a salt water spray test of sample 1, wherein FIG. 5(a) is an appearance photograph when a fitting portion side is viewed from directly above, FIG. 5(b) is an appearance photograph when a barrel portion side is viewed from directly above, FIG. 5(c) is an appearance photograph when the fitting portion side is viewed laterally and FIG. 5(d) is an appearance photograph when the barrel portion side is viewed laterally, and

FIG. 6 are photographs showing a result of the salt water spray test of sample 1C, wherein FIG. 6(a) is an appearance photograph when a fitting portion side is viewed from directly above, FIG. 6(b) is an appearance photograph when a barrel portion side is viewed from directly above, FIG. 6(c) is an appearance photograph when the fitting portion side is viewed laterally and FIG. 6(d) is an appearance photograph when the barrel portion side is viewed laterally.

### EMBODIMENTS OF THE INVENTION

In the above connector terminal, the metal base material is made of Fe-based alloy. The Fe-based alloy is an alloy mainly containing Fe. A Fe content in the Fe-based alloy is equal to or more than 90 mass % in terms of improving terminal strength and reducing material cost. The Fe-based alloy may contain one, two or more types of elements such as C, Mn, Si, Mo, Al, P, Cu, Cr and Ni as alloy elements other than Fe.

In the above connector terminal, the surface of the metal base material is mostly covered by a plating film. However, the above connector terminal includes the base material exposed part formed by exposing a part of the surface of the metal base material to outside.

In the above connector terminal, the base material exposed part may be present at a punched fracture surface formed by punching the terminal material and/or at a bent portion formed by bending the terminal material.

The punched fracture surface is not covered by the plating film. Further, the metal base material is covered by the plating film at the bent portion before bending, but the plating film is cracked during bending to expose the metal base material in some cases. Thus, if these parts are not covered by the coating films made of the anti-rust oil, the corrosion of the metal base material easily progresses from these parts. In contrast, since these parts are covered by the coating films made of the anti-rust oil in the above connector terminal, an improvement of corrosion resistance is made reliable.

In the above connector terminal, the plating film may include a Sn plating film or a Sn alloy plating film. In this case, a balance among a reduction of contact resistance, an improvement of corrosion resistance, the ensuring of connection reliability and the like is excellent. Note that the plating film may contain, for example, a Ni plating film or a Ni alloy plating film on a side closer to the metal base material than the Sn plating film or Sn alloy plating film. This case is advantageous such as in improving the adhesion of the plating film.

In the above connector terminal, anti-rust oil composed of an anti-rust conditioner, an oil film conditioner and a base for dissolving these conditioners can be used as the anti-rust oil. Examples of the anti-rust conditioner include metal sulfonates, ester compounds, and aliphatic acids. Examples of the oil film conditioner include waxes and resins. Examples of the base include petroleum mineral oils.

In the above connector terminal, the coating film made of the anti-rust oil may partially or entirely cover the base material exposed part. In terms of improving corrosion resistance, the coating film preferably covers the entire base material exposed part. Further, in the above connector terminal, the coating film made of the anti-rust oil may cover the plating film surface other than at the base material exposed part as long as electrical characteristics and the like of the connector terminal are not impaired.

The terminal shape of the above connector terminal is not particularly limited. The above connector terminal may specifically have various terminal shapes such as the shapes of a male terminal including a tab portion, a female terminal including a fitting portion to which a tab portion is to be electrically connected, a substantially L-shaped board connector terminal and an intermediate terminal.

Note that the respective configurations described above can be arbitrarily combined if necessary to obtain the functions, effects and the like described above.

### Embodiments

Hereinafter, connector terminals of embodiments are described using drawings.

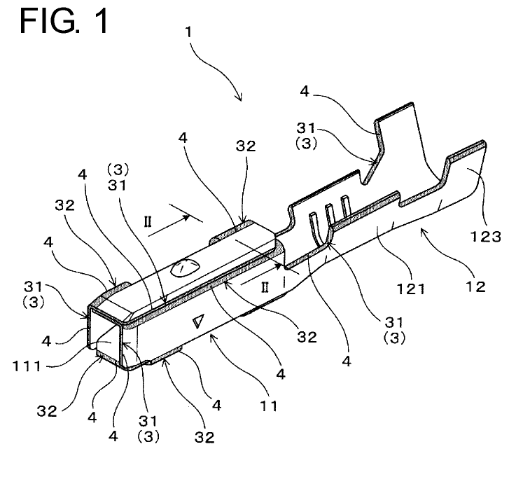

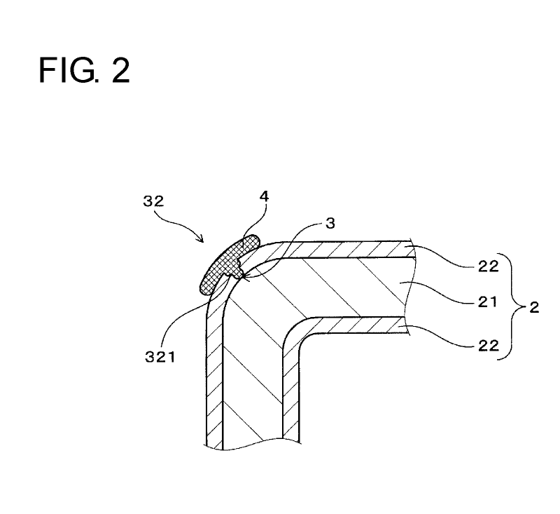

A connector terminal of a first embodiment is described using FIGS. 1 and 2. As shown in FIGS. 1 and 2, the connector terminal 1 is made of a terminal material 2 including plating films 22 on surfaces of a metal base material 21.

In this example, the connector terminal 1 is specifically a female terminal as shown in FIG. 1 and used for a connector (not shown) of a wiring harness for automotive vehicle. More specifically, the connector terminal 1 includes a fitting portion 11 in the form of a rectangular tube and a barrel portion 12 connected to the fitting portion 11.

A tab portion of a male terminal (not shown) as a mating terminal to be electrically connected is inserted into the fitting portion 11. A resilient contact piece 111 is formed inside the fitting portion 11 by folding a base plate portion of the fitting portion 11 inwardly and rearwardly. The resilient contact piece 111 is provided with a contact portion (not shown). The resilient contact piece 111 presses the tab portion inserted into the fitting portion 11 and is electrically connected to the tab portion through the contact portion. The barrel portion 12 includes a wire barrel portion 121 and an insulation barrel portion 122. The wire barrel portion 121 is crimped to a conductor exposed at an end part of an insulated wire (not shown) and electrically connected to the conductor. The insulation barrel portion 122 is crimped to an insulator of the insulated wire. The wire barrel portion 121 and the insulation barrel portion 122 have a substantially U shape in a cross-section perpendicular to a longitudinal direction of the connector terminal 1.

In the connector terminal 1, the metal base material 21 constituting the terminal material 2 is made of Fe-based alloy. In this example, the metal base material 21 is specifically made of Fe-based alloy containing 90 mass % or more of Fe. Further, in this example, the plating film 22 constituting the terminal material 2 is a Sn plating film and, specifically, formed by a reflow process of Sn plating formed on the surface of the metal base material 21.

Here, the connector terminal 1 includes base material exposed parts 3 formed by exposing the metal base material 21. In this example, the connector terminal 1 is formed by punching the plate-like terminal material 2 into a blank, which can be configured into the above terminal shape, using a press and bending the blank. Thus, in the connector terminal 1, the base material exposed parts 3 are present at punched fracture surfaces 31 formed by punching the above terminal material 2. Further, the connector terminal 1 includes bent portions 32 formed by bending the above terminal material 2. The bent portion 32 possibly includes a cracked part 321 formed by the crack of the plating film 22 during bending. Thus, in the connector terminal 1 of this example, the base material exposed part 3 is possibly present also at the bent portion 32.

The connector terminal 1 includes coating films 4 made of anti-rust oil and covering surfaces of the base material exposed parts 3. In this example, the punched fracture surfaces 31 exposed on outer surfaces of the connector terminal 1 and the bent portions 32 bent at 90° are covered by the coating films 4. The anti-rust oil specifically contains an anti-rust conditioner, an oil film conditioner and a base for dissolving these conditioners. Thus, the coating film 4 made of the anti-rust oil includes an adsorption layer (not shown) adsorbed to the metal base material 21 and an oil layer (not shown) arranged on the adsorption layer.

Next, functions and effects of the connector terminal of this example are described.

In the connector terminal 1 of this example, even if the metal base material 21 is made of Fe-based alloy, the surfaces of the base material exposed parts 3 where the metal base material 21 is exposed are covered by the coating films 4 made of the anti-rust oil. Thus, in the connector terminal 1 of this example, direct contact of the base material exposed parts 3 having a low corrosion resistance and moisture is made difficult by the coating films 4, whereby corrosion resistance can be improved.

Further, since the anti-rust oil is applied to the base material exposed parts 3 present at the punched fracture surfaces 31 and the bent portions 32 in the connector terminal 1 of this example, an improvement of corrosion resistance is made reliable.

Further, in the connector terminal 1 of this example, Fe-based alloy constituting the metal base material 21 contains 70 mass % or more of Fe. Thus, the connector terminal 1 of this example can contribute to an improvement of terminal strength and a reduction of material cost.

Further, in the connector terminal 1 of this example, the coating film 22 is composed of the Sn plating film. Thus, the connector terminal 1 of this example is excellent in balance among a reduction of contact resistance, an improvement of corrosion resistance, the ensuring of connection reliability and the like.

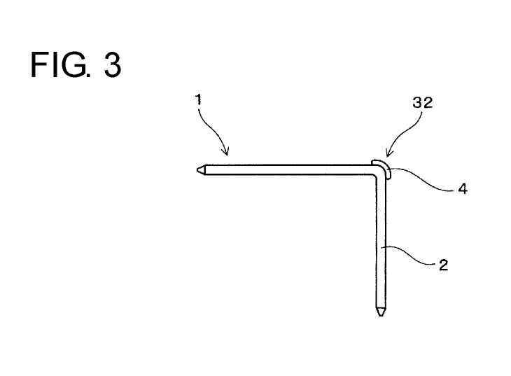

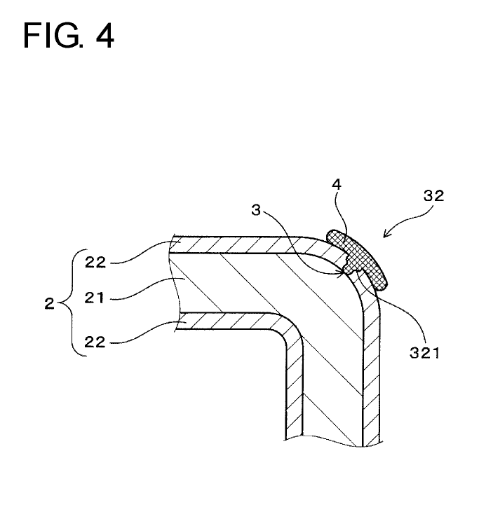

A connector terminal of a second embodiment is described using FIGS. 3 and 4.

As shown in FIGS. 3 and 4, the connector terminal 1 of this example is a pin terminal and in the form of a substantially “L-shaped” terminal. The connector terminal 1 is specifically used in a board connector (not shown) applied to a PCB.

The connector terminal 1 of this example is, more specifically, fabricated by cutting a linear terminal material 2 to a predetermined length and bending this cut piece at 90° at an intermediate position to form a bent portion 32. Besides, the connector terminal 1 can also be fabricated by punching a plate-like terminal material 2 to form a punched piece and bending this punched piece at 90° at an intermediate position to form a bent portion 32.

In the connector terminal 1, the bent portion 32 includes a cracked part 321 formed by a cracked plating film 22 during bending. Thus, in the connector terminal 1 of this example, a base material exposed part 3 is present at the bent portion 32. This part is covered by a coating film 4 made of anti-rust oil. The other configurations are as in the first embodiment.

Although a metal base material 21 is made of Fe-based alloy also in the connector terminal 1 of this example, direct contact of the base material exposed part 3 having a low corrosion resistance and moisture is made difficult by the above coating film 4, whereby corrosion resistance can be improved. Other functions and effects are as in the first embodiment.

The present design is more specifically described using experimental examples below.

A plate-like terminal material was prepared in which Sn plating films (thickness of 1.2 μm) made of reflow Sn plating were formed on surfaces of a plate-like metal base material (plate thickness of 0.3 mm) containing 0.4 mass % of C and the balance being Fe and unavoidable impurities.

Subsequently, the plate-like terminal material was punched into a blank which can be configured into a 0.64 female terminal shape using a press and the blank was bent, whereby a 0.64 female terminal was obtained. Note that the metal base material was exposed at punched fracture surfaces in the obtained female terminal. Further, in the obtained female terminal, the plating film was cracked in parts of bent portions and the metal base material was exposed in the cracked parts.

Coating films were formed by applying anti-rust oil to base material exposed parts at the punched fracture surfaces and the bent portions on outer surfaces of the female terminal, whereby sample 1 was obtained. Further, sample 1C was obtained in the same way as described above except that the anti-rust oil was not applied at all. Note that P-18C produced by Chelest Corporation was used as the anti-rust oil.

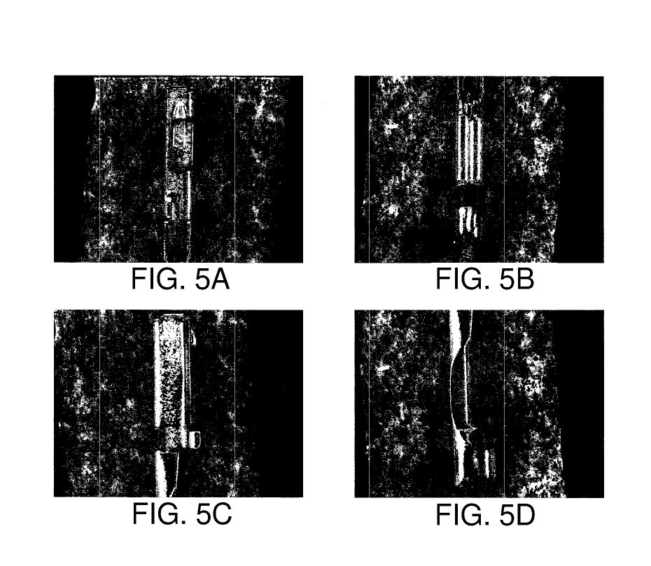

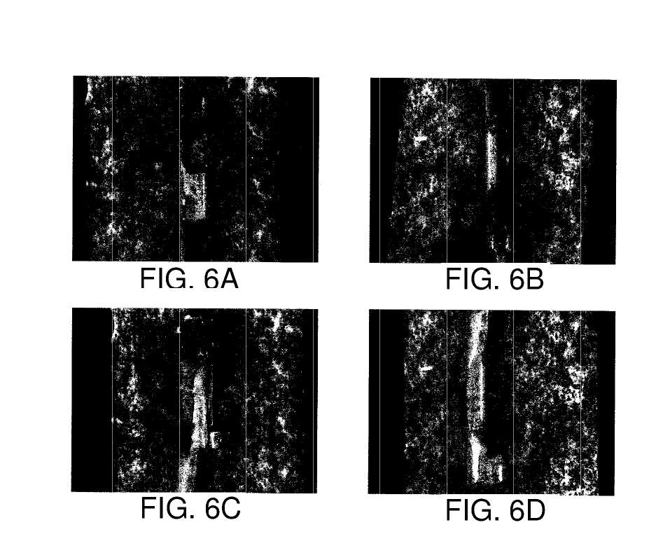

Subsequently, after salt water containing 5 mass % of salt (liquid temperature of 25° C.) was sprayed to each sample for 96 hours, a state of corrosion was observed. A result of that is shown in FIGS. 5 and 6.

As shown in FIG. 6, in sample 1C, surfaces of the base material exposed parts present at the punched fracture surfaces and surfaces of the base material exposed parts present at the bent portions are not coated by the coating films made of the anti-rust oil. Thus, it is understood that the base material exposed parts is easily corroded and corrosion spreads over the entire terminal in sample 1C.

In contrast, as shown in FIG. 5, surfaces of the base material exposed parts present at the punched fracture surfaces and surfaces of the base material exposed parts present at the bent portions are coated by the coating films made of the anti-rust oil in sample 1. Thus, it is confirmed that the base material exposed parts is not corroded and corrosion resistance is improved in sample 1.

Although the embodiments of the present invention have been described in detail above, the present invention is not limited to the above embodiments and various changes can be made without departing from the gist of the present invention.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A connector terminal made of a terminal material including a plating film on a surface of a metal base material, wherein:
the metal base material is made of a Fe-based alloy containing 90 mass % or more of Fe; and
the connector terminal includes a base material exposed part formed by exposing the metal base material and a coating film made of anti-rust oil and covering a surface of the base material exposed part with the plating film exposed on a terminal outer surface.

2. A connector terminal according to claim 1, wherein the base material exposed part is present at a punched fracture surface formed by punching the terminal material and/or at a bent portion formed by bending the terminal material.

3. A connector terminal according to claim 1, wherein the plating film includes a Sn plating film or a Sn alloy plating film.

4. (canceled)
